(19) United States
(12) Patent Application Publication
(10) Pub. No.: US 2024/0195273 A1
(43) Pub. Date: Jun. 13, 2024

(54) METHOD FOR PRODUCING AN ELECTROMAGNET, PREFERABLY FOR A STATOR OF AN ELECTRIC MOTOR, AND ELECTROMAGNET

(71) Applicant: Schaeffler Technologies AG & Co. KG, Herzogenaurach (DE)

(72) Inventor: Markus Dietrich, Oberkirch (DE)

(73) Assignee: Schaeffler Technologies AG & Co. KG, Herzogenaurach (DE)

(21) Appl. No.: 18/286,997

(22) PCT Filed: Apr. 6, 2022
(86) PCT No.: PCT/DE2022/100259

§ 371 Date: Oct. 14, 2023

(30) Foreign Application Priority Data
Apr. 29, 2021 (DE) 10 2021 111 029.7

(51) Int. Cl. H02K 15/02; H02K 1/14

(52) U.S. Cl. CPC H02K 15/026; H02K 1/148; H02K 2215/00

(57) ABSTRACT

The disclosure relates to a method for producing an electromagnet in which laminated cores comprising sheet metal elements are stamped out of a plurality of metal sheets lying one on top of the other to form teeth. The sheet metal elements of the laminated cores are pressed together. The laminated cores that are located next to one another are wound with the coil winding in opposite directions to produce a magnetic pole and the wound laminated cores are joined to form the electromagnet While the sheet metal elements of the laminated cores are stamped out of the metal sheets, continuous connections between the sheet metal elements of all the laminated cores located in at least an identical position remain, the connections being used as assembly aids when the electromagnet is constructed. The connections are interrupted during or after the construction of the electromagnet.

### CROSS-REFERENCE TO RELATED APPLICATIONS

This application is the U.S. National Phase of PCT Application No. PCT/DE2022/100259 filed on Apr. 6, 2022, which claims priority to DE 10 2021 111 029.7 filed on Apr. 29, 2021, the entire disclosures of which are incorporated by reference herein.

### TECHNICAL FIELD

The disclosure relates to a method for producing an electromagnet and to an electromagnet.

### BACKGROUND

When producing an electromagnet for use in an electric motor, it is known to stamp laminated cores in the form of teeth out of a plurality of stacked sheet metal elements and then to wrap a coil winding around each tooth to form an electromagnetic pole. The teeth can be produced individually and positioned on a tool for winding with the coil winding. Care must be taken to ensure that only stampings from one line of the sheet metal press are used for the electromagnet. Alternatively, chains of multiple teeth can be stamped out, with the teeth being fully connected over their outer radius, with the webs being installed in the electric motor with the electromagnet.

### SUMMARY

The object underlying the disclosure is that of specifying a method for producing an electromagnet and an electromagnet in which the effort involved in assembling the electromagnet is simplified also on installation in the electric motor.

The object is achieved by the foregoing discussion.

In the method explained above, laminated cores comprising sheet metal elements are stamped out of a plurality of metal sheets lying one on top of the other and shaped as teeth, with the sheet metal elements of the laminated cores being pressed together. Next, a core winding is wound around each laminated core to yield an electric magnetic pole. The coil winding is wound in opposing directions around adjacent laminated cores and the wound laminated cores are joined together to form the electromagnet. In this method, continuous connections, connectors, or connecting webs between the sheet metal elements, which are in at least the same position, of all the laminated cores are retained during stamping of the sheet metal elements of the laminated cores out of the metal sheets lying one on top of the other. The continuous connections serve as assembly aids when assembling the electromagnet, with the connections being broken during or after assembly of the electromagnet. Connection of the laminated cores with the connecting webs eliminates the major effort that is required when unstacking the individual teeth from the press and when introducing the individual teeth into a workpiece carrier. Thus, no additional effort is required to ensure all the teeth have the same height limit stop. Breaking of the connecting webs on assembly of the electromagnet prevents the formation of gaps between the teeth in the yoke area that contain air and thus negatively influence magnetic flux density. Thus, in addition to the simplified assembly process, high electromagnet efficiency is made possible.

According to an example embodiment, the continuous connections between the individual wound laminated cores automatically break off during assembly of the electromagnet, such as during a process of rolling up. As a result, an additional assembly step for separating the continuous connections can be dispensed with.

According to an example embodiment, the continuous connections between the individual wound laminated cores are broken after the electromagnet has been assembled. This means that adjustment of the individual laminated cores to one another remains unaffected. In addition, a smooth contact point is created between the continuous connections.

According to an example embodiment, when stamping the laminated cores, a stamping tool is used, which creates a through hole in the sheet metal elements of all the laminated cores that are on the outside on one side and at the same time creates the continuous connections between the sheet metal elements stamped out of the outer sheet in the outer sheet from which the outer sheet metal elements are produced. One stamping tool is saved since the through openings and continuous connections are made with the same tool, which reduces the costs involved in producing the electromagnet.

A further aspect of the disclosure relates to an electromagnet, in particular for a stator of an electric motor, comprising a plurality of poles, each consisting of a laminated core having a plurality of sheet metal elements lying one on top of the other, which take the form of teeth, a coil winding being wound round each laminated core, the coil windings of two adjacent laminated cores being wound clockwise or counterclockwise around the respective laminated core. The assembly effort of the electromagnet is simplified since the sheet metal elements, located in the same position within all the laminated cores arranged next to one another, are connected to one another via continuous connections or connecting webs which are constructed from the same sheet of metal as the sheet metal elements located in the same position. This has the advantage that the individual laminated cores do not need to be sorted when the electromagnet is assembled and all the laminated cores of the electromagnet have the same height.

According to an example embodiment, the continuous connection or connecting web extends between the two adjacent laminated cores. As a result, only little space is required for the webs, which is why the size of the electromagnet remains largely unaffected.

According to an example embodiment, the connecting web of each laminated core is pulled outwards and the ends of the connecting webs of all the laminated cores are connected to a main connecting web formed from the same sheet of metal as the connecting webs and the sheet metal elements located in the same position. In this case, the width of the sheet metal available for stamping out the sheet metal stacks is utilized to the maximum. No additional material expenditure arises.

According to an example embodiment, each connecting web is formed pointing radially outwards in a region of the respective laminated core which is unaffected by a field pattern of a magnetic field generated by the current-carrying coil winding. As a result, the magnetic flux density remains unaffected by the web, which increases the efficiency of the electromagnet.

According to an example embodiment, the connecting web adjoins a recessed notch in the sheet metal elements of the laminated cores arranged in the same position, in particular in the region of a dovetail connection of the sheet metal elements of the laminated cores for coupling the laminated cores to a tool. This region is irrelevant to the function of the electromagnet, since no field lines run through it.

According to an example embodiment, the connecting webs are formed on the outer sheet metal elements of the laminated cores, which are acted upon by a stamping tool for stacking the laminated cores. As a result, the connecting webs are produced with the same stamping tool that is used for stacking, which entails a reduction in production costs.

### BRIEF DESCRIPTION OF THE DRAWINGS

The disclosure allows for numerous embodiments. One of these will be explained in greater detail with reference to the figures shown in the drawings.

### In the Figures:

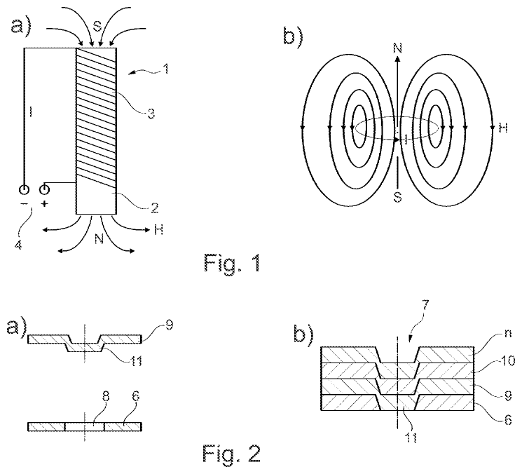

FIG. 1 shows a schematic representation of the mode of operation of an electromagnet,

FIG. 2 shows a schematic representation of a core of the electromagnet produced by stamping and stacking,

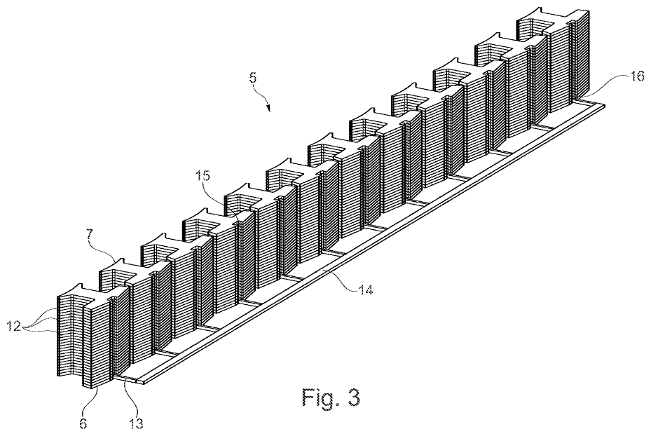

FIG. 3 shows a first exemplary embodiment of a core for a stator of an electric motor produced by the method according to the invention,

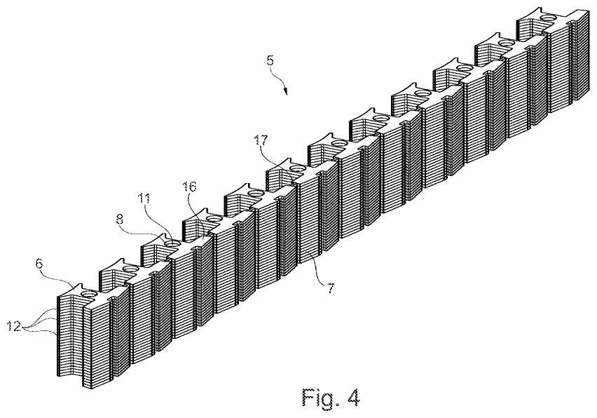

FIG. 4 shows a further exemplary embodiment of the core for a stator of an electric motor produced by the method according to the invention.

### DETAILED DESCRIPTION

FIG. 1 shows a schematic representation of the mode of operation of an electromagnet. According to FIG. 1a, the electromagnet 1 consists of a ferromagnetic core 2 which is surrounded by a coil winding 3. The coil winding 3 is connected to an electrical power source 4. If a current I flows through the coil winding 3, a magnetic field H builds up around it, which is amplified by the ferromagnetic core 2 (FIG. 1b).

Electromagnets 1 which are used in electric motors have a stator core 5, which is manufactured from a plurality of metal sheets lying one on top of the other in a stamping and stacking operation. Stamping and stacking combines the processes of stamping, forming and mechanical joining in one manufacturing material in which the metal sheets lying one on top of the other take the form of strip material. This joining process is based on the principle of stretch forming and pressing together the metal sheets that have been stamped out on top of one another. FIG. 2 shows the basic operation involved in this process. The first sheet 6 of each laminated core 7 is individually fully stamped through and receives through openings 8, as shown in FIG. 2a. The following metal sheets 9, 10, n are not fully stamped through, but receive indentations 11 which are pressed into one another, as shown in FIG. 2b. As a result of this expansion, radial forces arise in the indentations 11, which cause the individual sheets 6, 9, 10, n to be held together.

FIG. 3 shows a first exemplary embodiment of a stator core 5 as is used in an electric motor, which is used in particular as an actuator in clutches and transmissions of a motor vehicle. This stator core 5 is produced as a chain of a predetermined number of laminated cores 7 using the stamping and stacking process described. Each laminated core 7, which is formed into a tooth during stamping, comprises a plurality of sheet metal elements 12 lying one on top of the other after stamping. One of the outer metal sheets 6, which terminates the laminated core 7, is processed with a stamping tool which, in addition to the through openings 8 in sheet metal elements 12 formed from the metal sheet 6 and positioned next to one another, simultaneously stamps connecting webs 13 out of the metal sheet 6, which connect the sheet metal elements 12 of the metal sheet 6 to one another. The connecting webs 13 are pulled outwards parallel to one another and are connected to one another via a main connecting web 14. Advantageously, the connecting webs 13 are held in a recessed notch 16 in the area of a dovetail 15. Such a trapezoidal dovetail 15 is part of a dovetail connection the complementary counterpart of which is formed on a tool carrier, not shown in detail, and with which the stator core 5 is attached to the tool carrier. After the stator core 5 has been applied to the tool carrier, the laminated cores 7 are surrounded by the coil winding 3, with two adjacent laminated cores 7 having coil windings that are applied in opposing directions (one winding clockwise, the other winding counterclockwise). As a result, current flows through these coil windings 3 in the opposing direction when they are connected to the power source 4 and they thus form positive and negative magnetic poles. After completion of the winding process, the chain of laminated cores 7 carrying the coil winding 3 and connected by the connecting webs 13 is rolled up to form the stator. The connecting webs 13 are then cut off by means of a cutting device.

A further exemplary embodiment of the stator core for an electric motor produced by the method according to the invention is shown in FIG. 4. The connecting webs 17 are formed directly between the individual laminated cores 7 to connect the sheet metal elements 12 of the outer metal sheet 6. These connecting webs 17 are also stamped out with the same stamping tool as the through openings 8 and thus simultaneously therewith. During the rolling process of the chain of laminated cores 7 held together by the connecting webs 17, these connecting webs 17 break off automatically.

In the solutions described, the connecting webs 13, 17 are each formed only between the sheet metal elements 12 of the outer metal sheet 6. However, there is also the possibility that these are stamped out on a plurality of the superimposed metal sheets 9, 10, n in order to improve handling of the electromagnet 1 during the assembly process.

### LIST OF REFERENCE SYMBOLS

1 Electromagnet
2 Ferromagnetic core
3 Coil winding
4 Power source
5 Stator core
6 Outer metal sheet
7 Laminated core
8 Through hole in the outer metal sheet
9 Metal sheet
10 Metal sheet
11 Indentation
12 Sheet metal element
13 Connecting web
14 Main connecting web
15 Dovetail.
16 Notch
17 Connecting web
I Current
H Magnetic field
n Metal sheet

1. A method for producing an electromagnet for a stator of an electric motor, the method comprising:
stamping a plurality of stacked metal sheets lying one on top of another so as to produce laminated cores comprising sheet metal elements shaped as teeth,
processing together the sheet metal elements of the laminated cores,
winding a coil around each laminated core so as to produce a magnetic pole, the coils wound in opposing directions around adjacent laminated cores, and
joining the wound laminated cores together so as to form the electromagnet, and
wherein connecting webs arranged to connect sheet metal elements, which are in at least a same position within each of the laminated cores, are retained from the stamping of the plurality of stacked metal sheets lying one on top of another, the connecting webs i) serving as assembly aids when assembling the electromagnet, and ii) configured to be broken during or after assembly of the electromagnet.

2. The method as recited in claim 1, wherein the connecting webs arranged between each of the laminated cores are configured to break off during assembly of the electromagnet.

3. The method as recited in claim 1, wherein the connecting webs arranged between each of the laminated cores are broken after assembly of the electromagnet.

4. The method as recited in claim 1, wherein when stamping the laminated cores, a stamping tool is used which simultaneously creates: i) a through hole in an outer sheet metal element of each of the laminated cores, and, ii) the connecting webs between the outer sheet metal elements.

5. An electromagnet for a stator of an electric motor, the electromagnetic comprising:
a plurality of poles, each pole of the plurality of poles comprising a laminated core having a plurality of sheet metal elements lying one on top of the other so as to form teeth,
a coil winding wound around each laminated core and a coil winding of two adjacent laminated cores wound in opposite directions, and
wherein,
the laminated cores arranged next to one another are connected to one another via connecting webs extending from first sheet metal elements located at a same position within each of the laminated cores, the connecting webs constructed from a same sheet of metal as the first sheet metal elements, and
the connecting webs are configured to be broken during or after assembly of the electromagnet.

6. The electromagnet as recited in claim 5, wherein the connecting webs extend between two adjacent laminated cores.

7. The electromagnet as recited in claim 5, wherein the connecting webs of the laminated cores extend outwards and connect to a main web formed from the same sheet of metal as the connecting webs and the first sheet metal elements.

8. The electromagnet as recited in claim 5, wherein the connecting webs extend radially outwardly in a region of a respective laminated core which is unaffected by a field pattern of a magnetic field generated by the coil winding.

9. The electromagnet as recited in claim 5, wherein the connecting webs adjoin a recessed notch formed in the first sheet metal elements, the recessed notch configured for coupling the laminated cores to a tool.

10. The electromagnet as recited in claim 5, wherein the first sheet metal elements are outer sheet metal elements of the laminated cores, the outer sheet metal elements configured to be acted upon by a stamping tool for stacking the laminated cores.

11. The method as recited in claim 1, wherein the connecting webs are arranged only between outer sheet metal elements of the laminated cores, the outer sheet metal elements configured to terminate the laminated cores.

12. The electromagnet as recited in claim 5, wherein the connecting webs are arranged only on the first sheet metal elements.

13. The electromagnet as recited in claim 12, wherein the first sheet metal elements are outer sheet elements configured to terminate the laminated cores.

14. The electromagnet as recited in claim 5, wherein the connecting webs are parallel to each other.

15. A method for producing an electromagnet for a stator of an electric motor, the method comprising:
stamping a plurality of stacked metal sheets lying one on top of another so as to produce:
laminated cores comprising a plurality of sheet metal elements shaped as teeth, the plurality of sheet metal elements including first sheet metal elements corresponding to an end position within each of the laminated cores, and
from one metal sheet of the plurality of stacked metal sheets:
the first sheet metal elements,
a plurality of connecting webs configured to connect the first sheet metal elements to one another,
pressing together the sheet metal elements of the laminated cores,
winding a coil around each laminated core so as to produce a magnetic pole, and
joining the laminated cores together so as to form the electromagnet, and
wherein the plurality of connecting webs are retained from the one metal sheet such that the plurality of connecting webs: i) serve as assembly aids when assembling the electromagnet, and ii) are configured to be broken during or after assembly of the electromagnet.

16. The method as recited in claim 15, wherein the plurality of connecting webs are arranged only between the first sheet metal elements.

17. The method as recited in claim 15, wherein the first sheet metal elements are outer sheet metal elements configured to terminate the laminated cores.

18. The method as recited in claim 17, wherein the plurality of connecting webs adjoin a recessed notch formed in the first sheet metal elements.

19. The method as recited in claim 17, wherein when stamping the laminated cores, a stamping tool is used to simultaneously create: i) a through hole in each of the outer sheet metal elements, and ii) the plurality of connecting webs configured to connect the outer sheet metal elements to each other.

20. The method as recited in claim 17, wherein the plurality of connecting webs are arranged only between the outer sheet metal elements.
